(19) United States
(12) Patent Application Publication
(10) Pub. No.: US 2022/0303016 A1
(43) Pub. Date: Sep. 22, 2022

(54) NANOSCALE CIRCUIT TO USE INCIDENT LASER RADIATION TO GENERATE AND RADIATE TERAHERTZ HARMONICS

(71) Applicant: Mark J. Hagmann, Salt Lake City, UT (US)

(72) Inventor: Mark J. Hagmann, Salt Lake City, UT (US)

(21) Appl. No.: 17/655,522

(22) Filed: Mar. 18, 2022

Related U.S. Application Data
(60) Provisional application No. 63/163,832, filed on Mar. 20, 2021.

(51) Int. Cl. H04B 10/50; H01S 3/16; H01S 3/11; H01Q 19/02

(52) U.S. Cl. CPC H04B 10/503; H01S 3/169; H01S 3/1112; H01Q 19/021; B82Y 20/00

(57) ABSTRACT

A nanoscale circuit has an optical antenna receiving the radiation from a mode-locked laser and it responds by transmitting selected microwave or terahertz frequencies with a separate orthogonal antenna. Only MIM diodes, low-pass filters, and a load resistor are used to generate, separate, and transmit at the harmonics of the laser pulse-repetition rate.

### CROSS-REFERENCES TO RELATED APPLICATIONS

This application claims priority as a non-provisional perfection of prior filed U.S. Application No. 63/163,832, filed Mar. 20, 2021, and incorporates the same by reference herein in its entirety.

### FIELD OF THE INVENTION

The present invention relates to the field of nanotechnology and more particularly relates to a nanoscale optical antenna that then transmits microwave and/or terahertz frequencies in response to radiation received.

### BACKGROUND OF THE INVENTION

An effort to solve the time-dependent Schrödinger equation was attempted by discovering resonances in the transmission of electrons that tunnel in a rectangular potential barrier with a height that oscillates sinusoidally in time. Modeling the effects of this resonance in laser-assisted field emission with CW lasers allowed the development of new methods to solve the time-dependent Schrödinger equation to study these resonances. This led to developing wideband-tunable oscillators based on laser-assisted field emission.

In first measurements of quantum tunneling in an oscillating potential, the primary windings of three insulated audio-frequency transformers were connected in series with a field emission tube and a floating DC high-voltage power supply. Two audio-frequency oscillators and an oscilloscope were connected to the three secondary windings. Tunneling currents at the harmonics and mixer frequencies for the two oscillators were measured with the oscilloscope. Analysis based on the Fowler-Nordheim equation shows that the magnitudes and frequencies of these currents are consistent with the non-linear relationship of the tunneling current to the total applied voltage in field emission. This effect could not be caused by photon processes because the photon energy at the audio frequencies is 12 orders of magnitude below the energy at the applied potentials.

Later, guided by simulations, we focused a mode-locked Ti:Sapphire laser on the tunneling junction of a scanning tunneling microscope (STM) to generate a microwave frequency comb (MFC) measuring hundreds of harmonics at integer multiples of the laser pulse-repetition frequency. The 200th harmonic, at 14.85 GHz, has a power of only 2.8 atto-watts but the signal-to-noise ratio is 25 dB. These extremely low-noise measurements in the sample circuit of the STM are possible because the linewidth is only 1.2 Hz. Thus, the quality factor (Q) exceeds 10¹⁰ to set the present state-of-the-art in low-noise microwave measurements. The power at each harmonic is inversely proportional to the square of its frequency. This roll-off is caused by the shunting capacitance of 6.4 pF for the connections to the tip and sample, and the 50-Ohm coaxial cable and the input impedance of the spectrum analyzer acting as a low-pass filter with a 3 dB point of 500 MHz. It is possible to remove the cabling from the tunneling junction and eliminate the low-pass filter. However, there would still be an inherent roll-off as the inverse square of the frequency that is caused by quantum phenomena at frequencies above 7 THz with a half-power point at 30 THz.

When measuring the MFC using a Ti:Sapphire laser, with a spectrum from 650 to 1180 nm (hv=1.91 to 1.05 eV) and a center wavelength of 800 nm (hv=1.55 eV), and using a gold sample (work function ϕ=5.5 eV) with a tungsten tip (ϕ=4.5 eV), the photon energy of the laser is much lower than the work functions for the sample and tip. Thus, it can be concluded that photon processes are unlikely. This conclusion is confirmed by the consistency of measurements of the microwave frequency comb with simulations using sequential quasistatic approximations with the Schrödinger equation.

### SUMMARY OF THE INVENTION

An improved nanoscale antenna may meet the following objectives: that it will be simple to construct and that it will transmit appropriate harmonic frequencies when stimulated by optical radiation. As such, a new and improved nanoscale antenna may comprise an optical monopole, a MIM tunneling diode, a low-pass filter (LPF), a resistor, and a second LPF, MIM diode, and optical monopole are connected in series on a horizontal line to accomplish these objectives. Radiation from a horizontally polarized mode-locked laser causes the MIM tunneling diodes and the LPFs to create a voltage drop across the resistor at harmonics of the laser pulse-repetition rate. Two vertical terahertz monopoles, pointing in opposed directions (defined as “up” and “down”), are at different ends of the resistor. Thus, the terahertz antenna is fed by this voltage drop to radiate at the harmonics. The optical and terahertz antennas have orthogonal polarization to reduce their mutual coupling. The output power is controlled by adjusting the laser, and the state-of-the art for narrow linewidth of the harmonics facilitates their detection.

The more prominent features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in several ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

FIG. 1 is a schematic drawing of an embodiment of a nanoscale antenna within the purview of the invention.

FIG. 2 is a schematic drawing of an alternate embodiment of a nanoscale antenna within the purview of the invention.

### DETAILED DESCRIPTION OF THE PREFERRED EMBODIMENT

With reference now to the drawings, a preferred embodiment of the nanoscale antenna is herein described. It should be noted that the articles “a,” “an,” and “the,” as used in this specification, include plural referents unless the content clearly dictates otherwise.

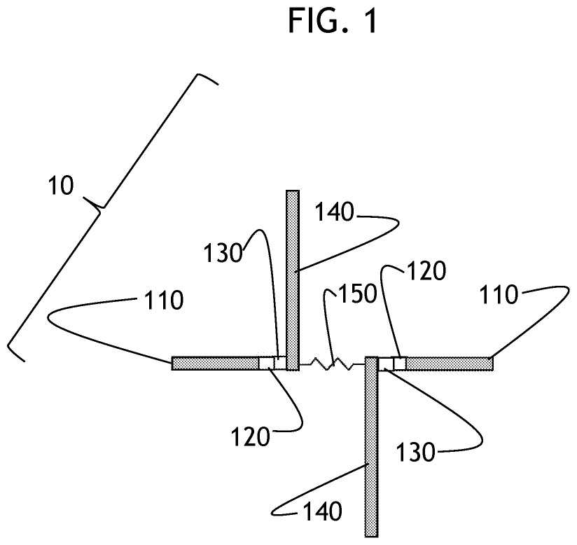

With reference to FIG. 1, We label the two parts of the spectrum of a mode-locked laser as the “optical spectrum” at and above the principal output frequency of the laser, and the “terahertz spectrum” that is below the principal frequency of the laser.

FIG. 1 is a sketch showing all the components of the nanoscale circuit. It is not drawn to scale because the vertical dipole 140 which transmits radiation in the terahertz spectrum is much longer than the horizontal optical dipole 110 that receives the radiation from the laser. The use of two separate antennas to receive the laser radiation 110 and radiate the harmonics 140 mitigates the roll-off of the output power as the inverse square of the frequency that is caused by the cabling and instrumentation in our measurements of the microwave frequency comb using a mode-locked laser with an STM. Each optical antenna 110 is coupled to a Metal-Insulator-Metal (MIM) diode 120 and then to a Low-Pass Filter (LPF) 130. A terahertz transmission antenna 140 is coupled to the LPF 130 and oriented perpendicularly to the optical antenna 100. Two such units are connected by a load resistor 150 between opposed transmission antennas 140, which are oriented to point in opposite directions, thereby leaving the two optical antennas 110 in line with each other and create the dipole.

The non-linear current-voltage characteristics of the two MIM tunneling diodes 120 create a current at closely spaced harmonics as integer multiples of the laser pulse-repetition rate. The voltage-drop across the resistor 150, which is at the feed-point for the vertical transmission dipole 140, causes radiation at these harmonics. Note that the result of this construction is that there are two coupled circuits, one receiving the laser radiation 110 and the other transmitting the harmonics which have much lower frequencies at much lower power 140. Coupling between the two antennas is minimized by their orthogonal positioning and the considerable difference between the terahertz and optical frequencies.

MIM tunneling diodes 120 are specified in this application because of their symmetric current-voltage characteristics, excellent high-frequency response, small size, and relative ease of fabrication. Others have previously used MIM tunneling diodes in terahertz applications. For example, a tungsten-nickel diode was used in a laser frequency synthesis chain to make measurements at frequencies up to 520 THz. We have used experiments with analysis to clarify the mechanism by which MIM diodes generate radiation at frequencies exceeding 500 THz.

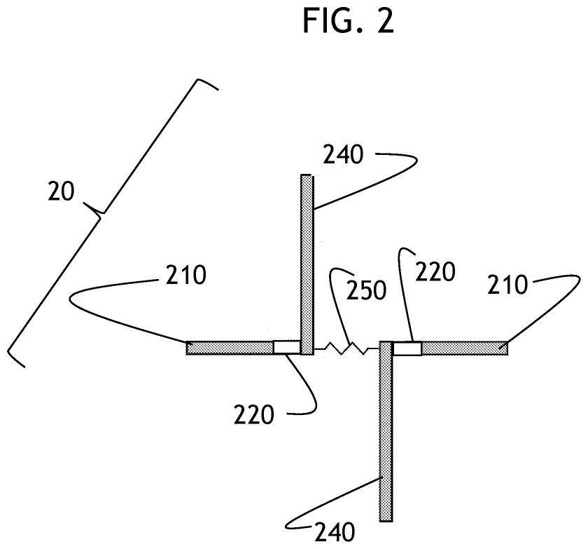

It is anticipated that it may not be necessary to include the low-pass filters, as is shown with the circuit 20 in FIG. 2, because of the impedance discontinuity that is presented by the resistor 250 and the terahertz antennas 240 at the optical frequencies, as well as the effect of the MIM diodes 220. Note that for both embodiments the length of the resistor 250 should be much less than the shortest wavelength for the terahertz harmonics that are of interest, so to limit the spacing of the two terahertz monopoles 240 to a small fraction of a wavelength and optimize the radiation pattern. The extremely short length of each segment with an optical monopole 110, MIM diode 120, and LPF 130, causes that part not to interfere with the flow of the terahertz harmonics through the two terahertz monopoles 140 and the resistor 150.

The dipole antenna is designed using classical antenna theory so that the impedance, radiation pattern, and other characteristics will enable it to radiate efficiently over a chosen bandwidth that corresponds to a specified set of adjacent harmonics. The extremely close spacing of 74.25 MHz between the adjacent harmonics seen in previous measurements shows that considerable information could be contained within each set. Thus, if many of these nanoscale circuits were being used simultaneously it would be possible to make simultaneous measurements from distinct groups of these devices. The two sections of the terahertz dipole would be fabricated using a suitable metal, such as gold.

The two optical monopoles 110, noted in the Figures, are essential to these nanoscale circuits. Summaries of the work on the new topic of optical antennas have been presented by others. Traditionally, in optics electromagnetic waves are redirected using tools such as lenses and mirrors that are much larger than the wavelength. By contrast, at radio wave and microwave frequencies, antennas much smaller than the wavelength are used to control the fields to direct the pattern of the radiation. An optical antenna has been defined as “a device designed to efficiently convert free-propagating optical radiation to localized energy, and vice versa.” Some work by others on resonant optical antennas including a resonant optical monopole. One exciting possibility for the present invention is to combine the function of each optical monopole with that of the corresponding metal-insulator-metal diode by fabricating the monopole on an adjacent dielectric layer. An antenna-coupled thin-film Ni—NiO—Ni diode with optical monopoles was previously fabricated and used with lasers by others in a different application where no optical mixing was done.

Present mode-locked lasers have a wide range of parameters including optical wavelengths from 0.5 to 20 μm, pulse repetition frequencies from 500 kHz to 1 THz, and pulse widths from 10 fs to 3 ps. A wide range of off-the-shelf mode-locked lasers is available, and the choice will be based on the requirements for a specific application.

Possible Applications of this Technology

Many nanoscale circuits could be distributed on a surface and the laser could be scanned over this surface to measure local phenomena with high resolution. For example, this approach could be used to determine the presence of damage to the surface. It would also be possible to develop devices for high-resolution measurements of various parameters such as the local temperature or ionizing radiation at high speeds with high spatial resolution.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A transmitting antenna for terahertz radiation, the antenna comprising two coupled circuits, each circuit further comprising:
an optical receiving antenna coupled to a MIM diode; and,
a transmission antenna operatively and orthogonally coupled thereto,
the two coupled circuits being coupled by a resistor between respective transmission antennas such that the optical receiving antennas of the two circuits are in line with each other and form a diopole and the transmission antennas of the two circuits are offset from one another and form a transmission dipole.

2. The transmitting antenna of claim on 3, further comprising a low pass filter located in each of the two coupled circuits, each low pass filter positioned between the MIM diode and transmission antenna of a respective coupled circuit.

3. A method of generating terahertz radiation, the method comprising:
a first step of providing at least one transmitting antenna having an optical receiving antenna dipole and a radiation transmission antenna dipole;
a subsequent step of irradiating the at least one transmission antenna with a mode-locked laser.
